(19) United States
(12) Patent Application Publication
(10) Pub. No.: US 2026/0341595 A1
(43) Pub. Date: Oct. 29, 2026

(54) CAPACITOR AND ELECTRONIC DEVICE

(71) Applicant: Trustcap Technology Co., Ltd., Zhunan Township (TW)

(72) Inventors: Hsiangtai CHEN, Zhunan Township (TW); Wenyen HUANG, Zhunan Township (TW); Chuanghui CHIU, Zhunan Township (TW)

(73) Assignee: Trustcap Technology Co., Ltd., Zhunan Township (TW)

(21) Appl. No.: 19/718,296

(22) Filed: Jun. 24, 2026

Related U.S. Application Data
(63) Continuation of application No. PCT/CN2024/130649, filed on Nov. 7, 2024.

(51) Int. Cl. H01G 2/06; H01G 4/224; H01G 4/232; H01G 4/248; H01G 4/30

(52) U.S. Cl. CPC H01G 2/065; H01G 4/224; H01G 4/232; H01G 4/248; H01G 4/30

(57) ABSTRACT

A capacitor and an electronic device are provided. The capacitor includes a carrier board and a capacitor body. A first side in a thickness direction of the carrier board is provided with a positive lead-out terminal, a negative lead-out terminal, and an auxiliary lead-out terminal. The capacitor body is disposed on a second side in the thickness direction of the carrier board. The first side and the second side are opposite along the thickness direction of the carrier board. The capacitor body includes a positive and a negative. The positive lead-out terminal is connected to the positive. The negative lead-out terminal and the auxiliary lead-out terminal are both connected to the negative. Along the extension direction of the carrier board, a distance between the auxiliary lead-out terminal and the positive lead-out terminal is smaller than a distance between the negative lead-out terminal and the positive lead-out terminal.

### CROSS REFERENCE TO RELATED APPLICATIONS

This application is a continuation of International Application No. PCT/CN2024/130649, filed on Nov. 7, 2024, the disclosure of which is hereby incorporated by reference in its entirety.

### TECHNICAL FIELD

The present application relates to the field of capacitor technologies and, more specifically, to a capacitor and an electronic device.

### BACKGROUND

Capacitors, as electronic components that store charges, are widely used in circuits of various electronic devices.

Taking a multilayer capacitor as an example: the multilayer capacitor in the related art includes multiple capacitor units, where the multiple capacitor units are stacked on a positive conductive terminal and a negative conductive terminal. A positive end of the capacitor unit is connected to the positive conductive terminal, and a negative end of the capacitor unit is connected to the negative conductive terminal. The multiple capacitor units are encapsulated by epoxy resin injection molding on an outer side thereof.

The above multilayer capacitor has problems such as a large size, high electrical lead-out resistance, and high equivalent series inductance.

### SUMMARY

The present application aims to provide a capacitor and an electronic device, which reduces the size of the capacitor, reduces the electrical lead-out resistance and equivalent series inductance, and improves the usability of the electronic device.

In a first aspect, the present application discloses a capacitor. The capacitor includes a carrier board and a capacitor body.

A first side in a thickness direction of the carrier board is provided with a positive lead-out terminal, a negative lead-out terminal, and an auxiliary lead-out terminal.

The capacitor body is disposed on a second side of the carrier board in the thickness direction. The first side and the second side are opposite along the thickness direction of the carrier board. The capacitor body includes a positive and a negative. The positive lead-out terminal is connected to the positive. The negative lead-out terminal and the auxiliary lead-out terminal are both connected to the negative.

Along an extension direction of the carrier board, a distance between the auxiliary lead-out terminal and the positive lead-out terminal is smaller than a distance between the negative lead-out terminal and the positive lead-out terminal.

In some embodiments of the present application, the negative is located on one side of the thickness direction of the capacitor body.

The carrier board is provided with a first conductive via. The first conductive via penetrates through the first side and the second side along the thickness direction of the carrier board.

The negative lead-out terminal and the auxiliary lead-out terminal are connected to the first conductive via, and are connected to the negative through the first conductive via.

In some embodiments of the present application, there are multiple first conductive vias, and the multiple first conductive vias are spaced apart along the extension direction of the carrier board.

The negative lead-out terminal and the auxiliary lead-out terminal are respectively connected to different first conductive vias.

In some embodiments of the present application, the capacitor further includes a first conductive layer and a second conductive layer.

The first conductive layer is disposed on the first side of the carrier board.

The second conductive layer is disposed on the second side of the carrier board, and located between the capacitor body and the carrier board; the second conductive layer is connected to the negative.

The first conductive layer is electrically connected to the second conductive layer through the first conductive via.

The auxiliary lead-out terminal is formed on one side of the first conductive layer near the positive lead-out terminal, and the negative lead-out terminal is formed on one side of the first conductive layer away from the positive lead-out terminal.

In some embodiments of the present application, the carrier board includes an insulating portion and a conductive portion that are connected with each other.

The insulating portion is provided with the positive lead-out terminal on one side away from the capacitor body.

The conductive portion is connected to the negative on one side near the capacitor body. A portion of the conductive portion near the positive lead-out terminal forms the auxiliary lead-out terminal, and a portion of the conductive portion away from the positive lead-out terminal forms the negative lead-out terminal.

In some embodiments of the present application, the capacitor further includes an insulating layer, the insulating layer is disposed on the first side of the carrier board and located between the positive lead-out terminal and the auxiliary lead-out terminal.

In some embodiments of the present application, the capacitor further includes a side negative electrode, the side negative electrode is disposed on a side of the capacitor and connected to the negative lead-out terminal and/or the auxiliary lead-out terminal.

In some embodiments of the present application, the positive is located on a side of the capacitor body.

The capacitor includes a side positive electrode, the side positive electrode is connected to the positive lead-out terminal and the positive.

Alternatively, the carrier board is further provided with a second conductive via. The second conductive via penetrates through the first side and the second side along the thickness direction of the carrier board.

The positive is connected to the positive lead-out terminal through the second conductive via.

In some embodiments of the present application, the capacitor body includes multiple capacitor units stacked along the thickness direction of the carrier board.

Positive structures of multiple capacitor units extend towards a same side of the capacitor body to form the positive of the capacitor body.

Negative structures of the multiple capacitor units are sequentially connected along a stacking direction, and the negative structures disposed on the adjacent side of the carrier board form the negative of the capacitor body.

In some embodiments of the present application, the capacitor further includes a stopper.

The capacitor unit includes a positive layer, a dielectric layer, and a negative layer stacked in sequence.

Along the extension direction of the carrier board, multiple first ends are disposed on a same side of the capacitor body to form the positive of the capacitor body.

The positive layer includes a first positive portion and a second positive portion. The second positive portion is disposed on a side of the first end of the first positive portion near the positive layer.

The dielectric layer covers an outer periphery of the first positive portion. The stopper is disposed on the second positive portion. The stopper is a hydrophobic member.

The negative layer covers an outer periphery of the dielectric layer.

In some embodiments of the present application, the capacitor body further includes a conductive support member.

The conductive support member is located between two adjacent layers of the capacitor units, connects the positive layers of two adjacent layers of the capacitor units, and is disposed near the first end of the positive layer.

In some embodiments of the present application, the capacitor body further includes a conductive connecting member. The conductive connecting member is located between two adjacent layers of capacitor units, and connects the negative layers of two adjacent layers of the capacitor units.

In some embodiments of the present application, the capacitor further includes a package, the package covers one side of the capacitor body away from the carrier board, as well as a side of the capacitor body.

The positive structure is exposed on a side of the package.

When the capacitor includes the side positive electrode, both the side positive electrode and the side negative electrode are located on an outer side of the package.

Along the extension direction of the carrier board, the side positive electrode and the side negative electrode are located on opposite sides of the package.

In a second aspect, the present application discloses an electronic device. The electronic devices include a capacitor.

Combining the above technical solutions, a capacitor and an electronic device are provided in the present application. The capacitor includes a carrier board and a capacitor body. A first side in a thickness direction of the carrier board is provided with a positive lead-out terminal, a negative lead-out terminal, and an auxiliary lead-out terminal. The capacitor body is disposed on a second side in the thickness direction of the carrier board. The capacitor body includes a positive and a negative. The first side and the second side are opposite along the thickness direction of the carrier board. The positive lead-out terminal is connected to the positive. The negative lead-out terminal and the auxiliary lead-out terminal are both connected to the negative. Along the extension direction of the carrier board, a distance between the auxiliary lead-out terminal and the positive lead-out terminal is smaller than a distance between the negative lead-out terminal and the positive lead-out terminal.

For the capacitor and the electronic device in the present application:
(1) The carrier board serves as a base of the capacitor, providing mechanical support for a bottom of the capacitor body to prevent mechanical damage to the bottom of the capacitor body, reducing the protective thickness under the capacitor body, reducing the size of the capacitor, and increasing the number of capacitor units per unit volume in the capacitor;
(2) The positive lead-out terminal is used for electrical connection with the positive of the capacitor body; the negative lead-out terminal and the auxiliary lead-out terminal are used for electrical connection with the negative of the capacitor body. The carrier board serves as a carrier and electrical lead-out, reducing the size of the capacitor, and increasing the number of capacitor units per unit volume in the capacitor;
(3) The positive and the negative of the capacitor body are directly led out through the carrier board, shortening a flow path of current in the capacitor, reducing the electrical lead-out resistance of the capacitor, improving the performance of the capacitor at a high frequency, and improving the usability of the electronic device;
(4) The auxiliary lead-out terminal is located between the positive lead-out terminal and the negative lead-out terminal. The negative of the capacitor body is led out through the auxiliary lead-out terminal, shortening the flow path of current in the capacitor, reducing the equivalent series inductance of the capacitor, reducing the power loss and heat generation of the capacitor, improving the performance of the capacitor at the high frequency, and improving the usability of the electronic device.

### BRIEF DESCRIPTION OF DRAWINGS

FIG. 1 is a schematic structural diagram of a capacitor in the related art.

FIG. 2 is a schematic structural diagram of current flow in a capacitor in the related art.

FIG. 3 is a schematic structural diagram of a capacitor from a first perspective provided by an Embodiment 1 of the present application.

FIG. 4 is a schematic structural diagram of a capacitor from a second perspective provided by an Embodiment 1 of the present application.

FIG. 5 is a schematic diagram of current flow in a capacitor provided by an Embodiment 1 of the present application.

FIG. 6 is a schematic diagram 1 of various parameters of equivalent series inductance in a capacitor provided by an Embodiment 1 of the present application.

FIG. 7 is a schematic diagram 2 of various parameters of equivalent series inductance in a capacitor provided by an Embodiment 1 of the present application.

FIG. 8 is a schematic structural diagram of a capacitor from a first perspective provided by an Embodiment 2 of the present application.

FIG. 9 is a schematic structural diagram of a capacitor from a second perspective provided by an Embodiment 2 of the present application.

FIG. 10 is a schematic diagram 1 of various parameters of equivalent series inductance in a capacitor provided by an Embodiment 2 of the present application.

FIG. 11 is a schematic diagram 2 of various parameters of equivalent series inductance in a capacitor provided by an Embodiment 2 of the present application.

FIG. 12 is a schematic structural diagram of a capacitor provided by an embodiment of the present application.

FIG. 13 is a schematic structural diagram of a capacitor unit provided by a capacitor of an embodiment of the present application.

FIG. 14 is an enlarged view of a M area in FIG. 13.

### DETAILED DESCRIPTION OF EMBODIMENTS

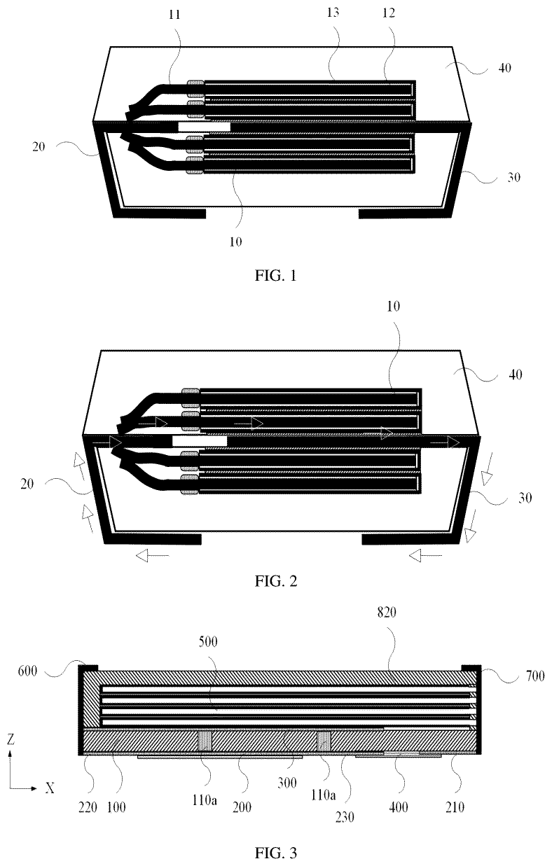

In the related art, a multilayer capacitor can achieve a high capacitance value in a small volume, thus, the multilayer capacitor is more suitable for a miniaturization requirement of a modern electronic device. Referring to FIG. 1 and FIG. 2, the multilayer capacitor includes multiple capacitor units 10, where the multiple capacitor units 10 are stacked on a positive conductive terminal 20 and a negative conductive terminal 30. A positive end of the capacitor unit 10 is connected to the positive conductive terminal 20, and a negative end of the capacitor unit 10 is connected to the negative conductive terminal 30. The multiple capacitor units 10 are encapsulated by epoxy resin 40 injection molding on an outer side thereof.

The capacitor unit 10 includes a positive layer 11, a dielectric layer 12, and a negative layer 13. The dielectric layer 12 covers a portion of an outer periphery of the positive layer 11, and the negative layer 13 covers the outer periphery of the dielectric layer 12. A portion of the positive layer 11 that is not covered by the dielectric layer 12 and the negative layer 13 forms the positive end of the capacitor unit 10. One positive layer 11, one dielectric layer 12, and one negative layer 13 form one capacitor unit 10. The multiple capacitor units 10 are stacked. The negative layer 13 between adjacent capacitor units 10 is connected by conductive adhesive.

Referring to FIG. 1, positive ends of positive layers 11 of multiple capacitor units 10 are connected to one end of the positive conductive terminal 20 through bending. The other end of the positive conductive terminal 20 is bent along one side of an encapsulation layer formed by the epoxy resin 40 and extends to a bottom of the encapsulation layer.

One end of the negative conductive terminal 30 is located between multiple capacitor units 10 and connected to the negative layer 13 of capacitor units 10. The other end of the negative conductive terminal 30 is bent along the other side of the encapsulation layer formed by the epoxy resin 40 and extends to the bottom of the encapsulation layer.

Referring to FIG. 1, the bent positive conductive terminal 20 and the bent negative conductive terminal 30 form a “flower rack” structure.

The multilayer capacitor disclosed in the above related art has at least the following disadvantages.
(1) Due to the need to encapsulate multiple capacitor units 10 with the epoxy resin 40 during a preparation process of the multilayer capacitor. The top and bottom of the capacitor unit 10 need to be encapsulated with the epoxy resin 40 to protect the capacitor unit 10. Encapsulation along the thickness direction of the multilayer capacitor leads to the problem of large thickness in the multilayer capacitor encapsulated with the epoxy resin 40, and then leads to the problem of large size in the multilayer capacitor. At the same time, this will also lead to the less number of capacitor units 10 accommodated per unit volume in the multilayer capacitor.
(2) Due to the fact that both the positive conductive terminal 20 and the negative conductive terminal 30 need to be bent, it is necessary to ensure sufficient space to accommodate the bending of the positive conductive terminal 20 and the negative conductive terminal 30 during a design process of the multilayer capacitor. At the same time, when bending the positive conductive terminal 20 and the negative conductive terminal 30, it is necessary to avoid the problem of excessive internal stress of the positive conductive terminal 20 and the negative conductive terminal 30 when a bending angle of the positive conductive terminal 20 and the negative conductive terminal 30 is too small. Therefore, a thickness and a length of this multilayer capacitor with a “flower rack” structure are limited by the bending of the positive conductive terminal 20 and the negative conductive terminal 30, and the multilayer capacitor has the problem of large size.
(3) Due to the fact that the positive end of the capacitor unit 10 is led out through the positive conductive terminal 20, and the negative end of the capacitor unit 10 is led out through the negative conductive terminal 30. The “flower rack” structure formed by the positive conductive terminal 20 and the negative conductive terminal 30 has a long lead-out distance. In this way, a flow path of current of the multilayer capacitor is longer, which will result in a higher electrical lead-out resistance. However, an increase in the electrical lead-out resistance can cause additional power loss and heat generation, higher electrical lead-out resistance can lead to a decrease in performance of the multilayer capacitor at a high frequency.

It should be explained that, in the capacitor, the electrical lead-out resistance usually refers to resistance possessed by the leads or terminals that are connected to the external circuit within the capacitor. The electrical lead-out resistance includes lead resistance, contact resistance, and electrode resistance. The lead resistance is caused by inherent resistance of capacitor leads or terminals. The contact resistance is the contact resistance between internal electrodes of the capacitor and the leads or terminals. The longer the flow path of the current in the multilayer capacitor is, the greater the lead resistance is, and usually the greater the electrical lead-out resistance is.
(4) Due to the fact that the positive conductive terminal 20 and the negative conductive terminal 30 are respectively located on two sides of the encapsulation layer of the epoxy resin 40. In this way, the flow path of current of the multilayer capacitor is longer, which leads to higher equivalent series inductance. The higher equivalent series inductance will increase the total impedance of the multilayer capacitor at the high frequency, reduce the filtering effect and instantaneous response of the multilayer capacitor, and increase the power loss of the multilayer capacitor.

It should be explained that, in the capacitor, the equivalent series inductance (ESL) refers to inductance characteristics exhibited by the capacitor in a circuit. Since the inductance is caused by a magnetic field around a conductor, a longer distance will generate a larger magnetic field loop.

In view of this, the present application provides a capacitor and an electronic device. The capacitor includes a carrier board and a capacitor body. A first side in a thickness direction of the carrier board is provided with a positive lead-out terminal, a negative lead-out terminal, and an auxiliary lead-out terminal. The capacitor body is disposed on a second side in the thickness direction of the carrier board. The first side and the second side are opposite along the thickness direction of the carrier board. The capacitor body includes a positive and a negative. The positive lead-out terminal is connected to the positive. The negative lead-out terminal and the auxiliary lead-out terminal are both connected to the negative. Along the extension direction of the carrier board, a distance between the auxiliary lead-out terminal and the positive lead-out terminal is smaller than a distance between the negative lead-out terminal and the positive lead-out terminal.

For the capacitor and the electronic device in the present application:
(1) The carrier board serves as a base of the capacitor, providing mechanical support for a bottom of the capacitor body to prevent mechanical damage to the bottom of the capacitor body. Compared to the related art, the capacitor provided in the embodiment of the present application does not need the use of the epoxy resin to encapsulate the bottom of the capacitor body. The carrier board in the capacitor provided in the embodiment of the present application not only protects the bottom of the capacitor body, but also reduces the protective thickness under the capacitor body, reduces the thickness of the capacitor and the size of the capacitor, and increases the number of capacitor units per unit volume in the capacitor;
(2) The first side in the thickness direction of the carrier board is provided with the positive lead-out terminal, the negative lead-out terminal, and the auxiliary lead-out terminal. The positive lead-out terminal is connected to the positive of the capacitor body for electrical connection; the negative lead-out terminal is connected to the negative of the capacitor body for the electrical connection of the negative; the auxiliary lead-out terminal is connected to the negative for providing the electrical connection for the negative. The carrier board serves as a carrier and electrical lead-out, the positive and the negative of the capacitor body are directly led out through the carrier board. Therefore, the capacitor provided in the embodiment of the present application is no longer limited by a “flower rack” structure in the related art, reducing the size of the capacitor and increasing the number of capacitor units per unit volume in the capacitor;
(3) By disposing the positive lead-out terminal, the negative lead-out terminal, and the auxiliary lead-out terminal on the carrier board, the positive and the negative of the capacitor body are directly led out through the carrier board, shortening the flow path of current in the capacitor, reducing the electrical lead-out resistance of the capacitor, improving the performance of the capacitor at the high frequency, and improving the usability of the electronic device;
(4) By designing the auxiliary lead-out terminal, disposing the distance between the auxiliary lead-out terminal and the positive lead-out terminal to be smaller than the distance between the negative lead-out terminal and the positive lead-out terminal, where the auxiliary lead-out terminal is located between the positive lead-out terminal and the negative lead-out terminal, the negative of the capacitor body may be led out through the auxiliary lead-out terminal, shortening the flow path of current in the capacitor, reducing the equivalent series inductance of the capacitor, reducing the power loss and the heat generation of the capacitor, improving the performance of the capacitor at the high frequency, and improving the usability of the electronic device.

To make the purposes, technical solutions and advantages of the present application more clearly, the technical solutions in the embodiments of the present application are described more detailed in the following with reference to the accompanying drawings of the preferred embodiments of the present application. In the accompanying drawings, the same or similar numbering throughout represents the same or similar components or components with the same or similar functions. It should be noted that the embodiments described in the present application are a part of the embodiments of the present application, and not all embodiments of the technical solution requested to be protected in the present application. The embodiments described below with reference to the accompanying drawings are merely exemplary contents and intended to explain the present application, and should not be understood as limitation of the present application. Based on the various embodiments described in the present application, all other embodiments obtained by ordinary skilled persons in the art without creative labor should fall within the protection scope of the present application. The embodiments of the present application will be described in detail with reference to the accompanying drawings in the following.

In a first aspect, an embodiment of the present application provides an electronic device. The electronic device includes capacitors. The electronic device provided in the embodiment of the present application may have various implementation forms, such as smartphones, tablets, laptops, base stations, routers, switches, portable monitoring devices, motor drivers, etc.

Due to multifunctionality and reliability of capacitors, they have become indispensable components in the electronic device. The structure of the capacitor will be introduced in detail in the following contents.

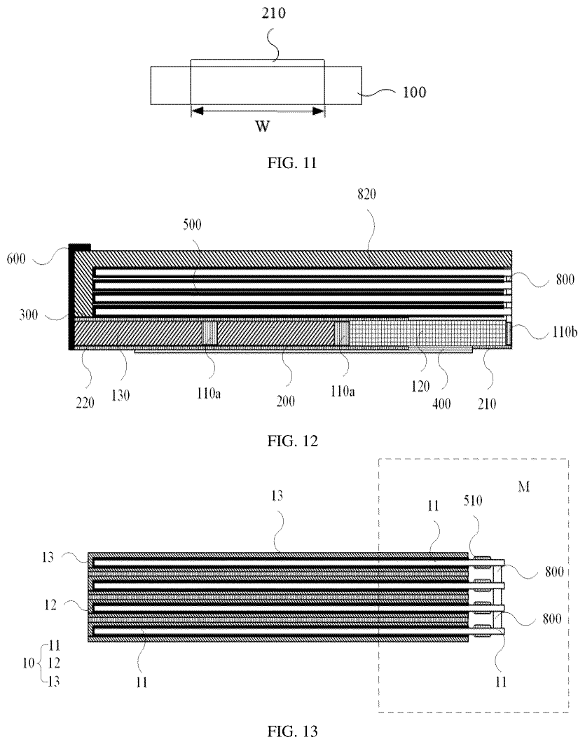

In a second aspect, the present application provides a capacitor, as shown in FIG. 3 to FIG. 13, the capacitor includes a carrier board 100 and a capacitor body 500. The carrier board 100 serves as a base for the capacitor, providing a foundation of mechanical support and electrical connection for the capacitor.

Referring to FIG. 3 to FIG. 5, a first side of the carrier board 100 in a thickness direction is provided with a positive lead-out terminal 210, a negative lead-out terminal 220, and an auxiliary lead-out terminal 230. The thickness direction of the carrier board 100 refers to a direction Z shown in FIG. 3. The positive lead-out terminal 210 is connected to a positive of the capacitor body 500 for electrical connection; the negative lead-out terminal 220 is connected to a negative of the capacitor body 500 for the electrical connection of the negative; the auxiliary lead-out terminal 230 is connected to the negative to provide the electrical connection for the negative.

The capacitor body 500 is located on a second side of the carrier board 100 in the thickness direction. The first side and the second side are opposite along the thickness direction of the carrier board 100. The capacitor body 500 includes the positive and the negative. The positive lead-out terminal 210 is connected to the positive. The negative lead-out terminal 220 and the auxiliary lead-out terminal 230 are both connected to the negative.

In the embodiment of the present application, the carrier board 100 not only protects a bottom of the capacitor body 500, but also reduces the protective thickness under the capacitor body 500, reduces the thickness of the capacitor, reduces the size of the capacitor, and increases the number of capacitor units 10 per unit volume in the capacitor.

When the thickness of the capacitor remains unchanged, the capacitor provided in the embodiment of the present application increases the number of capacitor units in the capacitor body 500. When the number of capacitor units remains unchanged, the capacitor provided in the embodiment of the present application reduces the thickness of the capacitor.

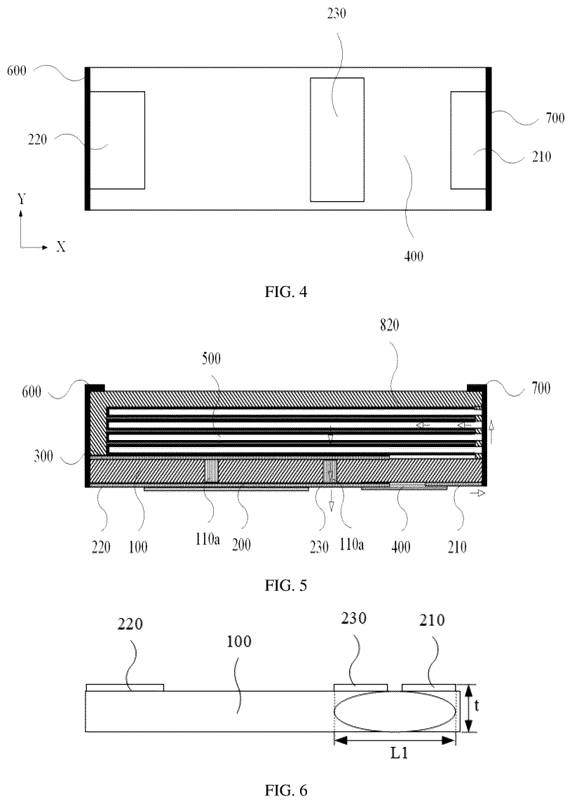

Further, as shown in FIG. 4, the positive lead-out terminal 210, the negative lead-out terminal 220, and the auxiliary lead-out terminal 230 are provided on the carrier board 100. The positive lead-out terminal 210 is connected to the positive of the capacitor body 500 for the electrical connection; the negative lead-out terminal 220 is connected to the negative of the capacitor body 500 for the electrical connection of the negative; the auxiliary lead-out terminal 230 is connected to the negative to provide the electrical connection for the negative. The carrier board serves as a carrier and electrical lead-out, the positive and the negative of the capacitor body 500 are directly led out through the carrier board 100, reducing the size of the capacitor and increasing the number of capacitor units 10 per unit volume in the capacitor.

For example, when the thickness of the capacitor in the related art is equal to that of the capacitor provided in the embodiment of the present application, the capacitor in the related art includes four capacitor units 10, and the number of capacitor units 10 in the embodiment of the present application is five. The capacity of the capacitor provided in the embodiment of the present application is increased by 25%.

For another example, when the thickness of the capacitor in the related art is equal to that of the capacitor provided in the embodiment of the present application, the capacitor in the related art includes six capacitor units 10, and the number of capacitor units 10 in the embodiment of the present application is seven. The capacity of the capacitor provided in the embodiment of the present application is increased by 16.7%.

In some embodiments, an effective width of the capacitor provided in the embodiment of the present application is 3.5 mm, an effective length is 5.85 mm, and an effective area is 20.475 mm². Compared to the related art, the effective width of the capacitor in the related art is 3.4 mm, the effective length is 4.9 mm, and the effective area is 16.66 mm². The effective area of the capacitor provided in the embodiment of the application has increased by 23% compared to the related art.

Referring to FIG. 2 and FIG. 5, in the embodiment of the present application, by disposing the positive lead-out terminal 210, the negative lead-out terminal 220, and the auxiliary lead-out terminal 230 on the carrier board 100, and the positive and the negative of the capacitor body 500 are directly led out through the carrier board 100, shortening the flow path of current in the capacitor, reducing the electrical lead-out resistance of the capacitor, improving the usability of the capacitor at a high frequency, and improving the usability of the electronic device.

The negative lead-out terminal 220 and the auxiliary lead-out terminal 230 are both connected to the negative of the capacitor body 500, which improves the degree of redundancy and a degree of fault tolerance of the capacitor, and increases the reliability of the capacitor.

By designing the auxiliary lead-out terminal 230, disposing a distance between the auxiliary lead-out terminal 230 and the positive lead-out terminal 210 to be smaller than a distance between the negative lead-out terminal 220 and the positive lead-out terminal 210, where the auxiliary lead-out terminal 230 is located between the positive lead-out terminal 210 and the negative lead-out terminal 220, shortening the flow path of current, reducing the equivalent series inductance of the capacitor, reducing the power loss and heat generation of the capacitor, improving the performance of the capacitor at the high frequency, and improving the usability of the electronic device.

As an achievable implementation, the negative is located on one side of the capacitor body 500 in the thickness direction.

The carrier board 100 is provided with a first conductive via 110a. The first conductive via 110a penetrates through the first side and the second side along the thickness direction of the carrier board 100.

The negative lead-out terminal 220 and the auxiliary lead-out terminal 230 are connected to the first conductive via 110a, and are connected to the negative through the first conductive via 110a. The first conductive via 110a is used for electrical connection, providing an electrical path from the negative lead-out terminal 220 and the auxiliary lead-out terminal 230 to the negative. By directly connecting the negative lead-out terminal 220 and the auxiliary lead-out terminal 230 to the negative of the capacitor body 500 through the first conductive via 110a, shortening the flow path of current, reducing the electrical lead-out resistance, and reducing the equivalent series inductance. This design improves the high-frequency performance and response speed of the capacitor. The first conductive via 110a provides a low impedance path, enhancing the current carrying capacity of the capacitor and enabling the capacitor to handle high current applications more effectively.

By integrating the first conductive via 110a in the carrier board 100, the thickness of the capacitor is reduced while achieving the electrical connection.

Exemplarily, a thickness range of the carrier board 100 is 0.25-0.30 mm.

Correspondingly, when the thickness range of the carrier board 100 is in a range of 0.25-0.30 mm, the carrier board 100 is usually able to provide sufficient mechanical strength and rigidity. This helps to protect the capacitor body 500 from effect of mechanical stress and shock, and a moderately thick carrier board 100 may effectively support formation of the first conductive via 110a and maintain its structural integrity. This is crucial for ensuring reliability and stability of the electrical connection.

Correspondingly, when the thickness of the carrier board 100 is greater than 0.30 mm, an excessively thick carrier board 100 will increase the overall size and weight of the capacitor, which is unsuitable for space limited or portable applications. The excessively thick carrier board 100 may cause an extension of a current path, increase the resistance and inductance, and affect the electrical performance.

Correspondingly, when the thickness of the carrier board 100 is less than 0.25 mm, an excessively thin carrier board 100 may not be sufficient to provide the necessary mechanical strength and is prone to bending or cracking during processing, assembly, or use.

Exemplarily, the thickness of the carrier board 100 may be 0.25 mm, 0.27 mm, 0.30 mm.

Exemplarily, the carrier board 100 may be a printed circuit board (PCB).

As an achievable implementation, there are multiple first conductive vias 110a, where the multiple first conductive vias 110a are spaced apart along an extension direction of the carrier board 100. The extension direction of the carrier board 100 refers to a direction X shown in FIG. 3.

The negative lead-out terminal 220 and the auxiliary lead-out terminal 230 are respectively connected to different first conductive vias 110a.

In some embodiments, as shown in FIG. 5, the number of first conductive vias 110a is two. Along the extension direction of the carrier board 100, the two first conductive vias 110a are spaced apart. The negative lead-out terminal 220 is connected to one first conductive via 110a. The auxiliary lead-out terminal 230 is connected to another first conductive via 110a. The first conductive via 110a connected to the auxiliary lead-out terminal 230 is nearer to the positive lead-out terminal 210 than the first conductive via 110a connected to the negative lead-out terminal 220.

During the use of the capacitor, the current flows through the positive lead-out terminal 210 to the positive of the capacitor body 500, and then the current flowing through the positive of the capacitor body 500 flows to the negative of the capacitor body 500, and then the current flowing through the negative flows to the auxiliary lead-out terminal 230. The flow direction of the current is shown by hollow arrows in FIG. 5. This embodiment is referred to as Embodiment 1.

By disposing the first conductive via 110a connected to the auxiliary lead-out terminal 230 nearer to the positive lead-out terminal 210, the distance between the positive and the negative of the capacitor body 500 is reduced, the current path is shortened, and the equivalent series inductance is reduced.

Compared to the related art, the capacitor provided in the embodiment of the present application shortens the current path by about 50%, thereby reducing the equivalent series inductance by 50%.

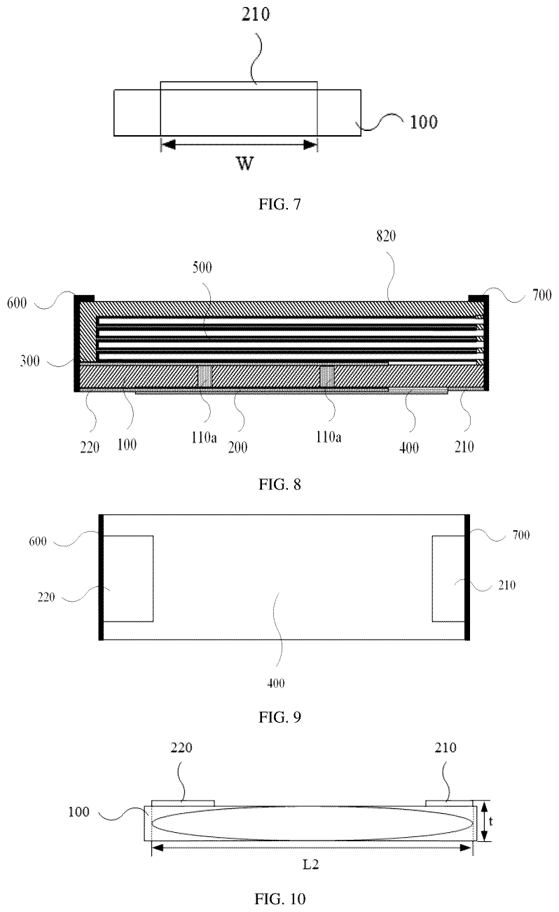

In other embodiments, as shown in FIG. 8 and FIG. 9, the number of first conductive vias 110a is two. Along the extension direction of the carrier board 100, the two first conductive vias 110a are spaced apart. The negative lead-out terminal 220 is connected to one first conductive via 110a. The auxiliary lead-out terminal 230 is connected to another first conductive via 110a. The first conductive via 110a connected to the auxiliary lead-out terminal 230 is nearer to the positive lead-out terminal 210 than the first conductive via 110a connected to the negative lead-out terminal 220.

During the use of the capacitor, the current flows from the positive lead-out terminal 210 to the positive of the capacitor body 500, and then the current flowing through the positive of the capacitor body 500 flows to the negative of the capacitor body 500, and then the current flowing through the negative flows to the negative lead-out terminal 220. This embodiment is referred to as Embodiment 2.

In the embodiment of the present application, the equivalent series inductance is denoted as A, and the equivalent series inductance A satisfies:

$$A = K \times \frac{L \times t}{W}$$

where, K is a constant, L is a distance between an end of the positive lead-out terminal 210 and an end of the negative lead-out terminal 220, W is a width of the positive lead-out terminal 210, and t is a height of the first conductive via 110a.

Referring to FIG. 5 to FIG. 7, in the Embodiment 1, the flow path of current in the capacitor is: the positive lead-out terminal 210, the positive, the negative, and the auxiliary lead-out terminal 230. A distance between the end of the positive lead-out terminal 210 and an end of the auxiliary lead-out terminal 230 is L1.

Referring to FIG. 8 to FIG. 11, in the Embodiment 2, the flow path of current in the capacitor is: the positive lead-out terminal 210, the positive, the negative, and the negative lead-out terminal 220. The distance between the end of the positive lead-out terminal 210 and the end of the negative lead-out terminal 220 is L2.

By comparing Embodiment 1 and Embodiment 2, it can be concluded that, on the basis that K is a constant, and the width W of the positive lead-out terminal 210 and the height t of the first conductive via 110a in the capacitor in Embodiment 1 are equal to those in Embodiment 2, the distance L1 between the end of the positive lead-out terminal 210 and the end of the auxiliary lead-out terminal 230 in Embodiment 1 is smaller than the distance L2 between the end of the positive lead-out terminal 210 and the end of the negative lead-out terminal 220 in Embodiment 2. According to the equivalent series inductance formula, the equivalent series inductance in Embodiment 1 is smaller than that in Embodiment 2. The Embodiment 1 shortens the flow path of current in the capacitor, reduces the equivalent series inductance of the capacitor, reduces the power loss and the heat generation of the capacitor, improves the performance of the capacitor at the high frequency, and improves the usability of the electronic device.

It can be understood that the number of first conductive vias 110a may be multiple. For example, the number of first conductive vias 110a may be 2, 3, or 4.

As an achievable implementation, the capacitor further includes a first conductive layer 200 and a second conductive layer 300.

The first conductive layer 200 is disposed on a first side of the carrier board 100.

The second conductive layer 300 is disposed on a second side of the carrier board 100, and located between the capacitor body 500 and the carrier board 100; the second conductive layer 300 is connected to the negative.

The first conductive layer 200 is electrically connected to the second conductive layer 300 through the first conductive via 110a.

The side of the first conductive layer 200 near the positive lead-out terminal 210 forms the auxiliary lead-out terminal 230, and the side of the first conductive layer 200 away from the positive lead-out terminal 210 forms the negative lead-out terminal 220.

Exemplarily, the first conductive via 110a connects the first conductive layer 200 and the second conductive layer 300 located on both sides of the carrier board 100, reducing the distance between the positive and the positive lead-out terminal 210 of the capacitor body 500, reducing the distance between the negative and the negative lead-out terminal 220 as well as the auxiliary lead-out terminal 230 of the capacitor body 500, reducing the electrical lead-out resistance of an electrical path, and improving the high-frequency performance and response speed of the capacitor. In this way, the capacitor is suitable for rapidly changing current environments. In addition, the design of the first conductive layer 200 and the second conductive layer 300 helps to increase mechanical strength of the carrier board 100 and also helps to heat dissipation of the capacitor.

By forming the auxiliary lead-out terminals 230 and the negative lead-out terminal 220 on the first conductive layer 200, flexible electrical connection options are provided to adapt to different circuit design requirements. This flexibility helps simplify layout and design of the carrier board 100.

As an achievable implementation, referring to FIG. 12, the carrier board 100 includes an insulating portion 120 and a conductive portion 130 that are connected with each other.

The positive lead-out terminal 210 is provided on one side of the insulating portion 120 away from the capacitor body 500.

The conductive portion 130 is connected to the negative on one side near the capacitor body 500. A portion of the conductive portion 130 near the positive lead-out terminal 210 forms the auxiliary lead-out terminal 230, and a portion of the conductive portion 130 away from the positive lead-out terminal 210 forms the negative lead-out terminal 220.

Exemplarily, the insulating portion 120 is used for electrical isolation, and the positive lead-out terminal 210 is provided on one side of the insulating portion 120 away from the capacitor body 500, and the positive lead-out terminal 210 is used to connect with the positive of the capacitor body 500.

The conductive portion 130 is directly connected to the negative, so that in the capacitor, the negative and the negative lead-out terminal 220 as well as the auxiliary lead-out terminal 230 forms a shorter electrical path, which reduces the electrical lead-out resistance. At the same time, since the positive is connected to the positive lead-out terminal 210, and the negative is connected to the negative lead-out terminal 220 or the auxiliary lead-out terminal 230, the equivalent series inductance of the capacitor is reduced. This improves the high-frequency performance and response speed of the capacitor.

At the same time, the layout of the conductive portion 130 allows for a more uniform current distribution, reduces the risk of local overheating, and improves the reliability and service life of the capacitor. By forming the auxiliary lead-out terminal 230 and the negative lead-out terminal 220 on the conductive portion 130, flexible electrical connection options are provided to adapt to different circuit design requirements. This flexibility helps simplify the circuit board layout and design.

By disposing the conductive portion 130, welding of the capacitor is reduced, complexity of connections is simplified, a manufacturing and assembly process of the capacitor is simplified, and production efficiency is improved.

Exemplarily, the conductive portion 130 includes a metal plate.

As an achievable implementation, the capacitor further includes an insulating layer 400, where the insulating layer 400 is disposed on a first side of the carrier board 100 and located between the positive lead-out terminal 210 and the auxiliary lead-out terminal 230. The design of the insulating layer 400 provides the electrical isolation for the capacitor, preventing an electrical short circuit between the positive lead-out terminal 210 and the auxiliary lead-out terminal 230. The insulating layer 400 may reduce electromagnetic interference and crosstalk between the positive and the auxiliary lead-out terminal 230, improve the electrical performance of the capacitor. The introduction of the insulating layer 400 allows for a more compact lead-out terminal layout without worrying about the short circuit, thereby improving design flexibility and space utilization.

In some embodiments, insulating varnish is provided between the positive lead-out terminal 210 and the auxiliary lead-out terminal 230. And insulating varnish is provided between the auxiliary lead-out terminal 230 and the negative lead-out terminal 220.

In other embodiments, insulating varnish is provided between the positive lead-out terminal 210 and the negative lead-out terminal 220. And insulating varnish covers the auxiliary lead-out terminal 230.

Exemplarily, the insulating layer 400 may be insulating varnish.

As an achievable implementation, the capacitor further includes a side negative electrode 600, where the side negative electrode 600 is disposed on a side of the capacitor and connected to the negative lead-out terminal 220 and/or the auxiliary lead-out terminal 230.

Exemplarily, the side negative electrode 600 provides an additional electrical connection path. By adding the side negative electrode 600, the capacitor can more effectively distribute and carry the current, and be suitable for high current applications and improve overall efficiency. The presence of the side negative electrode 600 enhances the redundancy of the electrical connection, improves the mechanical strength and the electrical reliability of the capacitor, and reduces the risk of single point failures.

In some embodiments, the side negative electrode 600 is connected to the negative lead-out terminal 220. During the use of the capacitor, the current flows sequentially to the positive lead-out terminal 210, the positive, the negative, the side negative electrode 600, and the negative lead-out terminal 220.

In other embodiments, the side negative electrode 600 is connected to the auxiliary lead-out terminal 230. During the use of the capacitor, the current flows sequentially to the positive lead-out terminal 210, the positive, the negative, the side negative electrode 600, and the auxiliary lead-out terminal 230.

In yet other embodiments, the side negative electrode 600 is connected to both the negative lead-out terminal 220 and the auxiliary lead-out terminal 230. There are two flow paths of current in the capacitor. During the use of the capacitor, the current flows sequentially to the positive lead-out terminal 210, the positive, the negative, the side negative electrode 600, and the negative lead-out terminal 220. At the same time, the current flows sequentially to the positive lead-out terminal 210, the positive, the negative, the side negative electrode 600, and the auxiliary lead-out terminal 230.

In some embodiments, the positive is located on the side of the capacitor body 500. Placing the positive on the side of capacitor body 500 may effectively utilize external space of the capacitor.

The capacitor includes a side positive electrode 700, where the side positive electrode 700 is connected to the positive lead-out terminal 210 and the positive.

By directly connecting the positive lead-out terminal 210 and the positive through the side positive electrode 700, the current path may be shortened, and at the same time, the connection stability between the positive of the capacitor body 500 and the positive lead-out terminal 210 may be improved.

In other embodiments, the carrier board 100 is further provided with a second conductive via 110b. The second conductive via 110b penetrates through the first side and the second side along the thickness direction of the carrier board 100. The positive is connected to the positive lead-out terminal 210 through the second conductive via 110b. By providing a dedicated second conductive via 110b for the positive, the current path may be optimized, the resistance and inductance may be reduced, thereby improving the electrical performance. In addition, different conductive vias are respectively designed for the positive and the negative (as well as possible auxiliary lead-out terminal 230). This design ensures that the electrical path of each electrode is independent, reducing the interference between electrodes.

Compared to the related art, the capacitance of the capacitor provided in the embodiment of the present application is increased by about 20%.

As an achievable implementation, the capacitor body 500 includes multiple capacitor units 10 stacked along the thickness direction of the carrier board 100. By stacking the multiple capacitor units 10, the total capacitance of the capacitor may be significantly increased within a limited volume, meeting a higher capacitance requirement.

Positive structures of the multiple capacitor units 10 extends towards a same side of the capacitor body 500 to form the positive of the capacitor body 500. Since all positive structures converging on the same side, the electrical connections become simpler and more direct. This reduces the complex internal wiring requirements of the capacitor and reduces the manufacturing complexity.

Negative structures of the multiple capacitor units 10 are sequentially connected along a stacking direction, and the negative structures disposed on the adjacent side of the carrier board 100 form the negative of the capacitor body 500.

The negative structure of each capacitor unit 10 is sequentially connected in the stacking direction. This means that the negative structure extends from one unit to a next unit to form a continuous electrical path, reducing the resistance and inductance when current passes through. The stacked structure provides additional mechanical support, enhances structural stability of the capacitor, and reduces the risk of failure caused by mechanical stress.

As an achievable implementation, referring to FIG. 13, the capacitor further includes a stopper 510.

The capacitor unit includes a positive layer 11, a dielectric layer 12, and a negative layer 13 stacked in sequence.

Along the extension direction of the carrier board 100, multiple first ends 11a are disposed on a same side of the capacitor body 500 to form the positive of the capacitor body 500.

The positive layer 11 includes a first positive portion and a second positive portion; the second positive portion is located on a side of the first positive portion that is near the first end 11a of the positive layer 11.

The dielectric layer 12 covers an outer periphery of the first positive portion. The stopper 510 is disposed at the second positive portion. The stopper 510 is a hydrophobic member.

The negative layer 13 covers an outer periphery of the dielectric layer 12.

Exemplarily, during a preparation process of the capacitor unit 10, it is necessary to cover the outer periphery of the positive layer 11 with the dielectric layer 12 and the negative layer 13. The outer periphery of the positive layer 11 is not completely covered by the negative layer 13. The first positive portion of the positive layer 11 needs to be covered by the dielectric layer 12 and the negative layer. The second positive portion of the positive layer 11 does not need to be covered by the negative layer 13. The second positive portion of the positive layer 11 is used to form the positive structure.

The stopper 510 is provided at the second positive portion of the positive layer 11. On the one hand, the stopper 510 may serve as a physical barrier to help accurately locate a covering area of the negative layer 13. By limiting an immersion position of the negative layer 13 on the positive layer coated with the dielectric layer, it may be ensured that the negative layer 13 only covers the first positive portion of the positive layer 11, thereby improving the accuracy of the negative layer 13 covering the outer periphery of the positive layer 11, and optimizing a geometric shape of the negative layer 13. Exemplarily, the positive layer 11 may be an aluminum layer. The dielectric layer 12 may be an aluminum oxide layer. The negative layer 13 may be polyaniline.

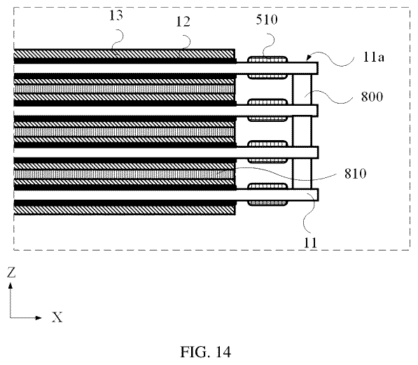

Compared to the related art, in the capacitor provided in the embodiment of the present application, the positive layer 11 does not need to be bent to form the positive structure. In the embodiment of the present application, the positive layer 11 extends in a direction X shown in FIG. 14 and is connected to the side positive electrode 700, reducing the space occupation of the positive layer 11 along a direction parallel to the extension direction of the carrier board 100 (i.e., the direction X shown in FIG. 14). In this way, more negative layers 13 can be distributed in the capacitor in the direction parallel to the extension direction of the carrier board 100, improving a space utilization rate inside the capacitor and increasing the capacitance of the capacitor.

Exemplarily, the stopper 510 may be silicone.

As an achievable implementation, referring to FIG. 13, the capacitor body 500 further includes a conductive support member 800.

The conductive support member 800 is located between two adjacent layers of capacitor units 10, connects the positive layer 11 of the two adjacent layers of capacitor units 10, and is disposed near the first end 11a of the positive layer 11.

The conductive support member 800 provides a low resistance path to connect the positive layers 11 of multiple capacitor units 10, thereby reducing the impedance between adjacent capacitor units 10 and reducing the electrical lead-out resistance. This helps to improve efficiency and frequency response of the capacitor. By connecting the positive layer 11 of adjacent capacitor units 10, the conductive support member 800 helps to achieve the uniform current distribution throughout an entire capacitor structure, reducing the local overheating and uneven current density problems.

In addition, aluminum material is selected for the positive layer 11, and the aluminum material has lower strength and is prone to deformation. The conductive support member 800 is provided between the positive layers of two adjacent layers of capacitor units 10, which can provide support for the positive layer 11 at the position of the first end 11a of the positive layer 11, avoiding deformation at the positive structure of the positive layer 11 and enhancing mechanical stability of the positive layer 11.

In some embodiments, the conductive support member 800 is provided at a position where the negative layer 13 is not covered in adjacent two positive layers. Multiple conductive support members 800 are spaced apart along the extension direction of the positive layer 11. The extension direction of the positive layer 11 refers to the direction X shown in FIG. 14.

Exemplarily, the conductive support member 800 may be a metal gasket. For example, an aluminum gasket.

As an achievable implementation, referring to FIG. 14, the capacitor body 500 further includes a conductive connecting member 810. The conductive connecting member 810 is located between two adjacent layers of capacitor units 10, connecting the negative layers of two adjacent layers of capacitor units 10.

The conductive connecting member 810 is located between two adjacent layers of capacitor units 10 and is specifically used to connect the negative structures of these units to ensure electrical continuity. The negative layer 13 between adjacent capacitor units 10 is connected through the conductive connecting member 810.

Exemplarily, the conductive connecting member 810 includes silver glue and carbon glue.

Exemplarily, an area of the negative layer 13 coated by the conductive connecting member 810 is equal to an area of the negative layer 13. The smaller the difference between a coating area of conductive connecting member 810 and the area of the negative layer 13 is, the more optimized a conductive path is, as well as the lower the impedance value after connecting the conductive connecting member 810 and the negative layer 13 is. The coating area of the conductive connecting member 810 should not be larger than the area of the negative layer 13, otherwise the excess portion may undergo adverse chemical reactions with other materials, affecting the stability and lifespan of the capacitor.

In some embodiments, the conductive connecting member 810 may be the silver glue. The silver glue has electrical conductivity. The silver glue may ensure effective transmission of current between capacitor units 10, reduce the resistance and energy loss, and improve the efficiency and high-frequency performance of the capacitor. The silver glue also has thermal conductivity, which helps to effectively dissipate heat, reduces the operating temperature of the capacitor, thereby improving the service life of the capacitor.

In other embodiments, the conductive connecting member 810 may be the carbon glue. The carbon glue has electrical conductivity. The carbon glue also has flexibility, which can adapt to the mechanical stress and thermal expansion that may occur during the use of the capacitor, reducing the risk of fracture and failure.

As an achievable implementation, the capacitor further includes a package 820, the package 820 covers one side of the capacitor body 500 away from the carrier board 100, as well as a side of the capacitor body 500. The package 820 covers a top of the capacitor body 500, providing physical protection for the capacitor and preventing environmental factors such as moisture, dust, and mechanical damage from affecting the capacitor, thereby improving durability and reliability of the capacitor. The package 820 may be epoxy resin.

The positive structure is exposed on a side of package 820. In this way, it is convenient for the positive structure to be connected with the positive lead-out terminal 210 through the side positive electrode 700. This design simplifies an installation and wiring process on the circuit board and improves assembly efficiency.

The side positive electrode 700 and the side negative electrode 600 are both located on the outer side of the package 820.

Along the extension direction of the carrier board 100, the side positive electrode 700 and the side negative electrode 600 are located on opposite sides of the package 820.

By arranging the side positive electrode 700 and the side negative electrode 600 on opposite sides of the package 820, electrical isolation is ensured. This layout reduces the risk of short circuits and electromagnetic interference, improving the safety and electrical performance of the capacitor.

In some embodiments, during the use of the capacitor, first, the current flows through the positive lead-out terminal 210 to the side positive electrode 700, then the current flowing through the side positive electrode 700 flows to the positive structure of each capacitor unit 10, then the current flows to the negative structure of each capacitor unit 10, then the current flows to the conductive connecting member 810, and then the current flows through the conductive connecting member 810 to the second conductive layer 300 on the second side of the carrier board 100, and finally the current flows through the second conductive layer 300 and the first conductive via 110a to the auxiliary lead-out terminal 230.

In other embodiments, during the use of the capacitor, first, the current flows through the positive lead-out terminal 210 to the positive structure of the capacitor unit 10 through the second conductive via 110b, then the current flows to the negative structure of each capacitor unit 10, then the current flows to the conductive connecting member 810, and then the current flows through the conductive connecting member 810 to the second conductive layer 300 on the second side of the carrier board 100, and finally the current flows through the second conductive layer 300 and the first conductive via 110a to the negative lead-out terminal 220.

In the description of the embodiments of the present application, it should be understood that, unless otherwise specified and limited, the terms “installation”, “connected”, and “connection” should be broadly understood, for example, they may be fixed connection, or indirectly connected through intermediate media, or connected internally between two components, or the interaction relationship between two components. For ordinary skilled in the art, the specific meanings of the above terms in the present application may be understood according to the specific situation. Directional or positional relationships indicated by the terms “up”, “down”, “front”, “back”, “vertical”, “horizontal”, “top”, “bottom”, “inside”, “outside” are directional or positional relationships based on the shown in the accompanying drawings, only for the convenience of describing the present application and simplifying the description, and do not indicate or imply that the apparatus or component referred to must have a specific orientation, be constructed and operated in a specific orientation, and therefore cannot be understood as a limitation of the present application. In the description of the present application, the meaning of “multiple” refers to two or more, unless otherwise specifically specified.

The terms “first”, “second”, “third”, “fourth”, etc. (if exists) in the specification and claims and the accompanying drawings of the present application are used to distinguish similar objects, rather than to describe a specific order or sequence. It should be understood that the data used in this way may be interchanged in appropriate circumstances, so that the embodiments of the present application described herein may, for example, be implemented in an order other than those illustrated or described herein. In addition, the terms “include” and “have”, as well as any variations thereof, are intended to cover non-exclusive inclusions, such as processes, methods, systems, products, or devices that contain a series of steps or units that are not necessarily limited to those steps or units clearly listed, but may include other steps or units that are not clearly listed or inherent to these processes, methods, products, or devices.

Finally, it should be noted that: the above embodiments are only used to illustrate the technical solutions of the present application, but not to limit it; although the present application has been illustrated in detail with reference to the foregoing embodiments, those of ordinary skill in the art should understand that: the technical solutions recorded in the foregoing embodiments may still be modified, or some or all of the technical features may be equivalently substituted; and these modifications or substitutions do not make the essence of the corresponding technical solutions deviate from the scope of the technical solutions of the embodiments of the present application.

Obviously, those skilled in the art can make various modifications and variations to the present application without departing from the spirit and scope of the present application. In this way, if these modifications and variations of the present application fall within the scope of the claims and their equivalent technologies of the present application, the present application is also intended to include these modifications and variations.

What is claimed is:

1. A capacitor, comprising:
a carrier board, wherein a first side in a thickness direction of the carrier board is provided with a positive lead-out terminal, a negative lead-out terminal, and an auxiliary lead-out terminal; and
a capacitor body disposed on a second side of the carrier board in the thickness direction; wherein the first side and the second side are opposite along the thickness direction of the carrier board; the capacitor body comprises a positive and a negative; the positive lead-out terminal is connected to the positive, and the negative lead-out terminal and the auxiliary lead-out terminal are both connected to the negative;
wherein along an extension direction of the carrier board, a distance between the auxiliary lead-out terminal and the positive lead-out terminal is smaller than a distance between the negative lead-out terminal and the positive lead-out terminal.

2. The capacitor according to claim 1, wherein the negative is located on one side of the thickness direction of the capacitor body;
the carrier board is provided with a first conductive via, wherein the first conductive via penetrates through the first side and the second side along the thickness direction of the carrier board; and
the negative lead-out terminal and the auxiliary lead-out terminal are connected to the first conductive via, and are connected to the negative through the first conductive via.

3. The capacitor according to claim 2, wherein there are multiple first conductive vias, and the multiple first conductive vias are spaced apart along the extension direction of the carrier board; and
the negative lead-out terminal and the auxiliary lead-out terminal are respectively connected to different first conductive vias.

4. The capacitor according to claim 2, further comprising:
a first conductive layer, disposed on the first side of the carrier board;
a second conductive layer, disposed on the second side of the carrier board and located between the capacitor body and the carrier board; the second conductive layer is connected to the negative;
the first conductive layer is electrically connected to the second conductive layer through the first conductive via; and
the auxiliary lead-out terminal is formed on one side of the first conductive layer near the positive lead-out terminal, and the negative lead-out terminal is formed on one side of the first conductive layer away from the positive lead-out terminal.

5. The capacitor according to claim 2, wherein the carrier board comprises an insulating portion and a conductive portion that are connected with each other;
the insulating portion is provided with the positive lead-out terminal on one side away from the capacitor body; and
the conductive portion is connected to the negative on one side near the capacitor body; a portion of the conductive portion near the positive lead-out terminal forms the auxiliary lead-out terminal; a portion of the conductive portion away from the positive lead-out terminal forms the negative lead-out terminal.

6. The capacitor according to claim 1, further comprising an insulating layer, wherein the insulating layer is disposed on the first side of the carrier board and located between the positive lead-out terminal and the auxiliary lead-out terminal.

7. The capacitor according to claim 1, further comprising a side negative electrode, wherein the side negative electrode is disposed on a side of the capacitor and connected to the negative lead-out terminal and/or the auxiliary lead-out terminal.

8. The capacitor according to claim 7, wherein the positive is disposed on a side of the capacitor body;
the capacitor comprises a side positive electrode, the side positive electrode is connected to the positive lead-out terminal and the positive; or
the carrier board is further provided with a second conductive via, the second conductive via penetrates through the first side and the second side along the thickness direction of the carrier board; and
the positive is connected to the positive lead-out terminal through the second conductive via.

9. The capacitor according to claim 8, wherein the capacitor body comprises multiple capacitor units stacked along the thickness direction of the carrier board;
positive structures of the multiple capacitor units extend towards a same side of the capacitor body to form the positive of the capacitor body; and
negative structures of the multiple capacitor units are sequentially connected along a stacking direction, and the negative structures disposed on the adjacent side of the carrier board form the negative of the capacitor body.

10. The capacitor according to claim 9, further comprising a stopper;
wherein the capacitor unit comprises: a positive layer, a dielectric layer, and a negative layer stacked in sequence;
along the extension direction of the carrier board, multiple first ends are disposed on a same side of the capacitor body to form the positive of the capacitor body;
the positive layer comprises a first positive portion and a second positive portion; the second positive portion is disposed on a side of the first end of the first positive portion near the positive layer;
the dielectric layer covers an outer periphery of the first positive portion; the stopper is disposed on the second positive portion; the stopper is a hydrophobic member; and
the negative layer covers an outer periphery of the dielectric layer.

11. The capacitor according to claim 10, wherein the capacitor body further comprises a conductive support member; and
the conductive support member is located between two adjacent layers of the capacitor units, connects the positive layers of two adjacent layers of the capacitor units, and is disposed near the first end of the positive layer.

12. The capacitor according to claim 10, wherein the capacitor body further comprises a conductive connecting member, and the conductive connecting member is located between two adjacent layers of the capacitor units, and connects the negative layers of two adjacent layers of the capacitor units.

13. The capacitor according to claim 9, further comprising a package, wherein the package covers one side of the capacitor body away from the carrier board, as well as a side of the capacitor body;
the positive structure is exposed on a side of the package; and
when the capacitor comprises the side positive electrode, both the side positive electrode and the side negative electrode are located on an outer side of the package; along the extension direction of the carrier board, the side positive electrode and the side negative electrode are located on opposite sides of the package.

14. An electronic device, comprising a capacitor, wherein the capacitor comprises:
a carrier board, wherein a first side in a thickness direction of the carrier board is provided with a positive lead-out terminal, a negative lead-out terminal, and an auxiliary lead-out terminal; and
a capacitor body, disposed on a second side of the carrier board in the thickness direction; wherein the first side and the second side are opposite along the thickness direction of the carrier board; the capacitor body comprises a positive and a negative; the positive lead-out terminal is connected to the positive, and the negative lead-out terminal and the auxiliary lead-out terminal are both connected to the negative;
wherein along an extension direction of the carrier board, a distance between the auxiliary lead-out terminal and the positive lead-out terminal is smaller than a distance between the negative lead-out terminal and the positive lead-out terminal.

15. The electronic device according to claim 14, wherein the negative is located on one side of the thickness direction of the capacitor body;
the carrier board is provided with a first conductive via, wherein the first conductive via penetrates through the first side and the second side along the thickness direction of the carrier board; and
the negative lead-out terminal and the auxiliary lead-out terminal are connected to the first conductive via, and are connected to the negative through the first conductive via.

16. The electronic device according to claim 15, wherein there are multiple first conductive vias, and the multiple first conductive vias are spaced apart along the extension direction of the carrier board;
the negative lead-out terminal and the auxiliary lead-out terminal are respectively connected to different first conductive vias.

17. The electronic device according to claim 15, wherein the capacitor further comprises:
a first conductive layer, disposed on the first side of the carrier board;
a second conductive layer, disposed on the second side of the carrier board and located between the capacitor body and the carrier board; the second conductive layer is connected to the negative;
the first conductive layer is electrically connected to the second conductive layer through the first conductive via; and
the auxiliary lead-out terminal is formed on one side of the first conductive layer near the positive lead-out terminal, and the negative lead-out terminal is formed on one side of the first conductive layer away from the positive lead-out terminal.

18. The electronic device according to claim 15, wherein the carrier board comprises an insulating portion and a conductive portion that are connected with each other;
the insulating portion is provided with the positive lead-out terminal on one side away from the capacitor body; and
the conductive portion is connected to the negative on one side near the capacitor body; a portion of the conductive portion near the positive lead-out terminal forms the auxiliary lead-out terminal; a portion of the conductive portion away from the positive lead-out terminal forms the negative lead-out terminal.

19. The electronic device according to claim 14, wherein the capacitor further comprises an insulating layer, wherein the insulating layer is disposed on the first side of the carrier board and located between the positive lead-out terminal and the auxiliary lead-out terminal.

20. The electronic device according to claim 14, wherein the capacitor further comprises a side negative electrode, wherein the side negative electrode is disposed on a side of the capacitor and connected to the negative lead-out terminal and/or the auxiliary lead-out terminal.
